(19) United States
(12) Patent Application Publication
(10) Pub. No.: US 2010/0056356 A1
(43) Pub. Date: Mar. 4, 2010

(54) METHODOLOGY AND TECHNOLOGY FOR THE PRODUCTION OF IMPROVED COAL DERIVED FLY ASH FOR THE PRODUCTION OF METAL MATRIX COMPOSITES

(76) Inventors: Thomas L. Robl, Sadieville, KY (US); John Wiseman, Revenna, KY (US); Brock Marrs, Lexington, KY (US)

Correspondence Address: KING & SCHICKLI, PLLC, 247 NORTH BROADWAY, LEXINGTON, KY, 40507, US

(21) Appl. No.: 12/549,803

(22) Filed: Aug. 28, 2009

Related U.S. Application Data
(60) Provisional application No. 61/092,980, filed on Aug. 29, 2008.

(51) Int. Cl. C04B 35/00

(52) U.S. Cl. 501/94; 501/155; 501/153

(57) ABSTRACT

A method for preparing a metal-fly ash composite material includes classifying a fly ash-containing material to provide a classified fly ash material having a mean particle size of from about 4 μm to about 40 μm. The classified fly ash material is blended with a metal matrix whereby the fly ash material and the metal matrix form a substantially homogenous mixture. Suitable conditions of temperature and/or pressure are applied to form a metal-fly ash composite material is formed. The metal matrix may be provided as a liquid or as a powder.

This utility patent application claims the benefit of priority in U.S. Provisional Patent Application Ser. No. 61/092,980 filed on Aug. 29, 2008, the entirety of the disclosure of which is incorporated herein by reference.

### TECHNICAL FIELD

The present invention relates to metal matrix composite materials, and in particular to such composite materials incorporating ash derived ceramic particles from coal combustion ash.

### BACKGROUND OF THE INVENTION

The United States is the largest mining country in the world. In 2001, the mining industry produced $57.3 billion in raw materials, of which $19.0 billion was derived from coal. The mineral processing industries increased the value of the minerals to $374 billion, while coal and uranium were used to produce $147 billion of electricity. Thus, the minerals and coal industries combined to contribute $521 billion to the nation's wealth (approximately 5.2% of the Gross National Product).

A major problem faced by the coal industry is environmental concerns created during coal production. According to a National Research Council report, the U.S. coal industry discards 70-90 million tons of fine coal annually to approximately 713 active impoundments. However, it is known in this art that such fine coal, if properly processed, finds use in a variety of industries, such as improving properties of concrete. Similarly, because of the potential utility of fine coal products such as fly ash, efforts have been made to incorporate such products into metal matrix composite (MMC) materials, with the goal of producing metal alloy composites of superior hardness, stiffness, and durability. Such composites also typically provide an end product of less weight than the corresponding metal or metal alloy.

Extensive efforts to fabricate ash-aluminum MMCs have met with limited success. In particular, the inconsistent quality of such materials in the past has greatly hampered development, and thus such materials have found limited success in the marketplace. For that reason, present commercial MMCs are typically based on SiC or Al₂O₃. However, the potential applications for suitable MMCs are extensive and have potentially great value. Using the motor vehicle industry as an example, simple replacement of ductile iron brake rotors with rotors fabricated of an MMC would provide significantly improved performance (due to at least improved thermal conductivity) and weight reduction, concurrently improving fuel efficiency of vehicles using such technology. Similarly, applications currently using hyper eutectic aluminum alloys, such as in manufacture of pistons, engine blocks, and heads, would benefit from incorporation of MMCs. In particular, in addition to the reduced cost of aluminum-ash MMCs compared to currently utilized MMCs, aluminum-ash MMCs can be machined with more conventional tooling, enhancing their desirability in such manufacturing processes.

In attempting to fabricate suitable MMCs such as aluminum-ash MMCs, it is necessary to address the issues of “wetability” and reactivity. In particular, it is not a simple matter to wet fly ash with molten aluminum, despite similarities in overall density of the materials. Thus, early efforts have resulted in end products with undesirable levels of porosity, and indeed with pockets of agglomerated ash in the form of stable flocs which are resistant to mechanical shear, and very difficult to disperse.

In addition, coal fly ash is formed in a highly oxidized environment, whereas molten aluminum is an extremely reducing environment. Thus, exposure of ash to molten aluminum creates oxidation-reduction reactions, forming spinel, reducing SiO₂ to Si metal, and other problematic reactions. Hydrogen formation forms voids, increasing porosity and decreasing strength of the final product. Release of alkali metals (i.e., Na and K) can “dewet” the ash.

Still further, fly ash is a heterogenous material, containing cenospheres, magnetite, and carbon, and also tends to include a wide range of particle sizes. This contributes to quality issues for the final MMC product.

Accordingly, there remains a need in this art for methods of producing MMCs which reduce reactivity of the fly ash component, to reduce the tendency to form flocs. There further remains a need in the art for such methods which reduces porosity of the final product and creates an end MMC product of improved hardness, stiffness, and strength.

### SUMMARY OF THE INVENTION

In one aspect, the present invention comprises reducing heterogeneity of fly ash intended for use in producing aluminum ash MMC, wherein the fly ash product is treated to remove contaminants such as cenospheres and the like. In one embodiment, the method comprises classifying a fly ash-containing material to provide a classified fly ash material having a mean particle size from about 4 μm to about 40 μm, blending the classified fly ash material with a metal matrix whereby the fly ash material and the metal matrix form a substantially homogenous mixture, and subjecting the mixture to suitable conditions of temperature and/or pressure whereby a metal-fly ash composite material is formed. The metal matrix may be in a molten state or a powder form.

The fly ash product may be classified by passage through a suitable classifier. The classifier may be any suitable classifier capable of separating out the finest (<5 μm) particles, minimizing surface area of the fly ash product. In this manner, reactivity of the fly ash is reduced, and also the tendency of the ash to form flocs. A classifier suitable for this method is set forth in U.S. patent application Ser. No. 11/451,672, the entirety of the disclosure of which is incorporated herein by reference.

A secondary thickening step may be applied to the classified fly ash material. In particular embodiments, the secondary thickening step may include one or more of: 1) re-passage of the material through the lamellar classifier; 2) passing the material through one or more elutriation columns; and 3) passing the material through a cone thickener.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims. Unless otherwise indicated, any patent and non-patent references discussed herein are incorporated in their entirety into the present disclosure specifically by reference.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 shows a scanning electron micrograph of ash derived ceramics (ADC);

FIG. 2 shows a metallographic photo of a representative test bar illustrating a thick reaction rim of the ADC;

FIG. 3 graphically presents tensile strength and modulus for various mixes;

FIG. 4 graphically presents tensile strength versus specific gravity for stir cast composites;

FIG. 5 graphically presents heat capacity as a function of temperature;

FIG. 6 shows a scanning electron micrograph of a 5% UFA ADC specimen showing lack of aluminum within clusters of ultrafine ADC;

FIG. 7 is a plot of maximum theoretical density as a function of compaction pressure for ALUMIX 123 and 231;

FIG. 8 is a correlation of tensile strength to hardness for a 5% UFA-ALUMIX 123 composite;

FIG. 9 graphically shows transverse rupture strength for various ADC materials; and

FIG. 10 shows thermal diffusivity as a function of temperature for increasing ADC %.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention. Also, it is to be understood that other embodiments may be utilized and that process, reagent, software, and/or other changes may be made without departing from the scope of the present invention.

Metal matrix composites are materials consisting of two or more distinct phases and exhibiting desirable properties derived from each phase. The objective of the present studies was to produce a lightweight ash-derived ceramic (ADC)-aluminum metal matrix composite (MMC) with improved stiffness and wear resistance. Such materials have application in a variety of industries, such as in the transportation industry to replace ductile iron in manufacture of, e.g., brake rotors, engine cylinders, and the like. Two primary methods for preparing ADC-aluminum MMC were evaluated, stir casting and powder metallurgy.

The ADC was found to readily wet within the aluminum alloy melt. Temperature control and melt stability were sources of variability within each stir casting melt as well as among the different materials. The cast bars were studied for tensile strength and modulus, heat capacity, thermal diffusivity, and thermal conductivity. Additionally, the cast materials were studied with metallography techniques. Overall, the ADC-aluminum MMC exhibited good machinability with standard silicon carbide tooling. Although the castings were not uniform and the results had variability, some specimens exhibited high stiffness and acceptable strength.

For the powder metallurgy experiments, coarse (32 microns) and ultrafine (<5 microns) ash derived ceramics were used as additives in commercially available aluminum alloy powders (Alumix®123 and 231, ECKA Granules, Orangeburg, S.C.). The ADC was added to the Alumix® powders in concentrations of 5% and 10% by weight. Compaction pressure, sintering temperature, soak time, heating rate, and compounding protocols were varied across a total of more than 500 test specimens. The resulting ADC-Alumix® MMC were characterized by testing for transverse rupture strength, bending modulus, Vickers microhardness, Rockwell hardness, and tensile strength. The data were highly reproducible. Optimal strengths were achieved with higher compaction pressure, higher sintering temperatures, and longer soak times compared to conventional aluminum alloys. Overall, powder metallurgy proved to be a feasible method for compounding and producing aluminum MMC reinforced with ash derived ceramics. Further, the results suggested that there is a strong potential to produce new breakthrough materials with unique combinations of hardness, strength, and wear resistance.

### Example 1

### Beneficiation of Coal Combustion Ash for Metal Matrix Composite Applications

Ceramic particles were derived from coal combustion ash using a hydraulic cross current lamellae classifier (U.S. patent application Ser. No. 11/451,672). After contaminants (cenospheres, iron-rich spinels, and coarse carbon) were separated from the ADC, they were classified into narrow size fractions. The ADC were further classified using a simple column elutriation technique. It was found that a cone thickener gave satisfactory results for secondary thickening of the ash product. Indeed, the final material selected for incorporation into MMC material typically included material having particle size of <5 μm in the 2-3 wt. % range. The LOI of the product (2-3%) was reduced further by calcining at 600 C, and that product was “dust blown” in a pneumatically fluidized bed to further remove fines. The final product typically included less than 2% of 5 micron material, with 10% or less of the surface area of the starting material.

The product also contained iron-rich particles that could detract from the production of metal matrix composites. In a separate investigation, the iron-rich particles were shown to react extensively with magnesium to produce iron-rich olivine, which is undesirable in MMCs. Iron-rich olivine is formed at temperatures slightly below 500 C, which are much lower than the temperatures required for sintering of aluminum pressed parts or stir casting. Since magnesium is a common alloying metal in aluminum, it was necessary to remove the iron-rich particles; otherwise, the reaction between the iron-rich particles and the magnesium could induce porosity and deformation into the MMC.

The iron-rich particles were removed by passing the dry powder products down an incline with magnets positioned underneath the platform. The magnets separated the iron-rich particles from the ceramic products. Several passes were made to ensure that all of the iron-rich particles were removed. The ceramic products were collected at the bottom of the incline. The iron-rich particles could also be removed while the product is in a slurry form. The slurry would be pumped through a channel containing magnets, which would separate the iron-rich particles from the ceramics. The iron-free product would then be dried, calcined, and “dust blown”, as previously described.

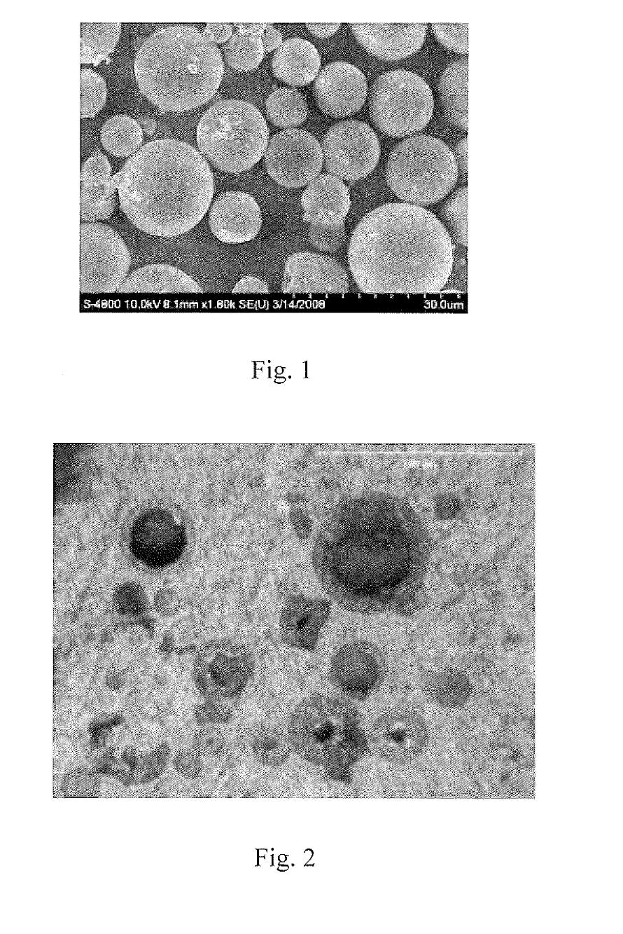

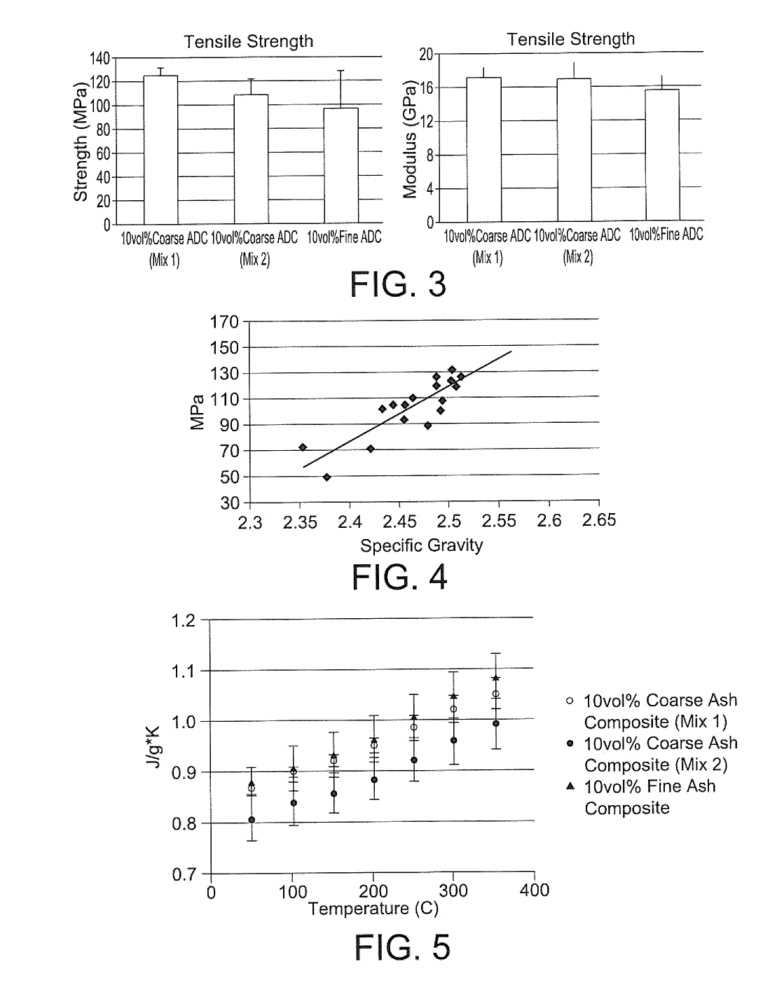

The collected ceramic particles were baked at 600° C. to remove all of the residual carbon. Scanning electron microscopy (SEM) was used to observe the quality and morphology of the ash derived ceramics. (FIG. 1). The product showed excellent morphology with very little contamination.

The mean particle size and particle size distribution of each collected batch of ceramic particles was measured using a Malvern Mastersizer 2000 particle size analyzer. The individual batches were mixed according to particle size to achieve three batches of ash derived ceramic particles—one with a mean particle size of 35 microns (coarse ADC), another with a mean particle size of 28 microns (fine ADC) and a third with a mean particle size of 4.5 microns (ultrafine ADC). Batches (˜50 lbs each) of the coarse and fine ADC were retained for evaluation.

### Example 2

### Stir Cast Formation of ADC-Aluminum Metal Matrix Composites

The matrix aluminum was selected to match the specifications for aluminum alloy 359, except that the magnesium content was increased from 0.7% to 1% to compensate for losses due to reaction with the ash derived ceramics (ADC). Prior to stir casting, the ADC powders were dried at 250° C. to remove any residual moisture. The aluminum 359 was prepared by blending A356 aluminum ingot with silicon and magnesium alloying elements. The alloy was melted in a small, tilting, electrically heated furnace and the mixture was degassed using purified argon. The temperature of the melt was monitored while it was transferred to a 55 kg vacuum mixer. Nitrogen gas was used to control oxidation of the aluminum in the mixer before mixing. After blending the alloy, the mixer was opened and the surface was skimmed to remove the surface oxide layer.

The ADC was added to the vacuum powder chamber of the mixer and the mixing chamber was evacuated. Once the impeller was lowered into the aluminum alloy melt, the warmed ADC was added to the mixing chamber. Observations were made through a viewport on top of the mixing chamber. After mixing, the chamber was vented with nitrogen gas and the impeller was removed. The surface of the melt was skimmed repeatedly while the melt was cast into JIS (Japanese Industrial Standard) ingots. The ingots were numbered consecutively up to 22. The remaining material was cast into 10 lb ingot molds.

Five mixes were produced using this process: 10 vol % coarse ADC in modified 359 aluminum, 10 vol % coarse ADC in modified 359 aluminum (repeat of the first group), 10 vol % fine ADC in modified 359 aluminum, 20 vol % fine ADC in modified 359 aluminum, and 20 vol % coarse ADC in modified 359 aluminum.

We found excellent wetting of the ADC by the aluminum alloy. The ADC flowed into the melt more smoothly than most silicon carbide powders, which is likely a result of the roundness of the particles. There was very little residual dust or fine particles indicating a relatively uniform distribution. The free flowing nature of the coarse ADC shortened the feed time into the melt (more rapid than typical silicon carbide powders). The ADC appeared to wet quickly with the molten alloy and enter the vortex of the mix without significant issue. The propensity for wetting was established by the rate at which the powder was accepted into the vortex. Powders that wet rapidly will disappear almost instantly when added to the melt; those that wet slowly will form a layer of dust on the surface of the melt for a period of time. It was found that even though the coarse ADC wetted slightly slower than silicon carbide, the wetting characteristics of the ADC were very good.

Despite good wetting and material compatibility, there were issues that arose during mixing. One such anomaly was the generation and expulsion of hydrogen gas in the melt after the ADC was added. The presence of residual water molecules in the ADC was believed to be the culprit. When immersed in the melt, the ADC released the water, which was instantly converted to hydrogen that burned weakly in the low pressure environment and oxygen that was immediately converted to oxides and retained in the mix. In general, the emanation of hydrogen and oxygen is problematic in stir casting because it increases the viscosity of the melt as well as the porosity levels within the castings.

A rise in the temperature of the melt after the ADC was added was also observed, potentially related to the interaction between the magnesium and the ADC as well as the exothermic formation of spinel. The ADC also appeared to separate from the mixture after longer mixing times. This ADC formed a viscous layer on top of the melt, which was later shown to have a high concentration of ADC. MC-21 indicated that this segregation might have led to a nonhomogeneous distribution of ADC in the cast ingots, especially in those cast towards the end of the melt. Each of these issues was exaggerated in the 20 vol % ADC materials.

After visual inspection, it was clear that the bars varied in quality from Mix 1 (10 vol % coarse ADC) through Mix 5 (20 vol % coarse ADC). In general, the bars with 10 vol % ADC were of superior quality than the bars with 20 vol % ADC, which were very porous and relatively weak. (FIG. 2).

The cast JIS bars were transversely sectioned to yield a thin cross-sectional specimen. The specimens were embedded in epoxy resin, grinded, and polished to a near mirror finish. The specimens were viewed with a Leica Orthoplan microscope (with digital camera attachment) and the morphological features were counted. Regions of ADC additive, mullite, spinel, quartz, aluminum, voids in the aluminum, voids in the ADC, and silicon were of particular interest. Each specimen was divided into three sections according to its respective orientation within the original ingot (i.e. top, middle, and bottom). The defined regions of interest were counted for each region. The percentage of each group within each region was calculated and extrapolated to provide estimated relative quantities for the entire specimen.

The observational results revealed that thick reaction rims were generated around the ADC in all specimens with some of the ADC reacting completely with the aluminum. (FIG. 2) As expected, aluminum dominated the composition of the specimens with 62%-88% of the total area. The second largest constituent (by area) was the ADC (7%-24%). These results corroborated the observation that there was an absence of uniformity among the individual casts. Furthermore, specimens selected out of the last casts (approaching cast number 22) for the 10 vol % fine ADC composites showed a sharp decline in ash derived ceramic content, which suggested that the uniformity of the ADC-aluminum mixture was time dependent. Over time, the ADC likely “floated” to the top of the casting mixture. Although metallographic imaging supported the claim that ADC wetted well within the melt, the specimens were inconsistent and secondary reaction products such as spinel and voids were present.

Cast bars from the 10 vol % coarse ADC-aluminum (Mixes 1 and 2) and 10 vol % fine ADC-aluminum mixes were machined into cylindrical “dog bones” for tensile testing in accordance with ASTM E8. Based on a four point qualitative (poor to excellent) rating of machinability, the MMC's were rated “good” as they produced curled or easily broken chips and a good to excellent finish. The amount of machining was insufficient to make reasonable judgments on tool wear.

At least six specimens were tested for each sample. The gauge length and diameter of each specimen were measured three times and averaged. Each cylindrical dog-bone specimen was mounted into the threaded tensile grips of an electromechanical Instron materials testing system (University of Kentucky). The specimens were pulled at a rate of 2 mm/min until failure occurred. In a few cases, the specimen failed in the grips. These specimens were discarded from analysis.

The difference in tensile strength of the first and second mixes of 10 vol % coarse ADC was likely due to increased incidence of non-uniformities and porosity in Mix 2. In general, the overall tensile strength increased with specific gravity (FIG. 4). The 10 vol % fine ADC specimens were saddled with higher porosity and, therefore, were weaker than the 10% coarse ADC materials. Increased porosity is also to blame for lower modulus values.

The heat capacity of the 10 vol % ADC materials was measured using modulated dynamic scanning calorimetry. The 20 vol % ADC materials were not studied because of the poor condition of the cast ingots. A small sample (<25 mg) from each specimen was pressed in aluminum pans and heated stepwise from 50° C. to 350° C. in increments of 50° C. At each temperature, the heating signal was modulated ±0.5° C. every 60 seconds for 10 minutes. The heat capacity at each temperature (measured as the reversing heat capacity) was measured three times and averaged. Three specimens from each sample were tested (FIG. 5). Heat capacity increased steadily with increasing temperature as expected. The porosity and regions of non-uniformity within the specimens likely caused the large standard deviations.

Thermal diffusivity was measured using laser flash analysis. Cylindrical specimens (12.5 mm diameter; 5 mm thick) were machined from the cast ingots. Each specimen was coated with graphite to prevent reflection of the laser. The laser conditions were set to 600V with a pulse width of 0.5 milliseconds. Three measurements were taken at each temperature (50, 100, 150, 200, 250, 300, and 350° C.) and the average diffusivity was used to calculate thermal conductivity. Thermal conductivity is the product of heat capacity, bulk density, and thermal diffusivity at a select temperature.

As expected, materials containing ADC were more insulating than the aluminum 359 (138 W/m*K; taken from literature). The average thermal conductivity of the 10 vol % coarse ADC material (89.0 W/m*K) was virtually the same as that of the 10 vol % fine ADC material (90.2 W/m*K); however, the standard deviation for the latter was much higher. Although the variance within this data was too high to determine any statistical significance among the groups, it was valuable for reaffirming that the ash-aluminum mixes were not uniform when they were cast.

### Example 3

### Powdered Metal Formation of Aluminum-ADC WIC's.

Ash derived ceramic-aluminum composites produced with powder metallurgy (P/M) technology have many advantages. The ADC are spherical, which aids in compaction and does not induce anisotropy in the final product. The ADC have a Mohs hardness that is much less that competing materials, such as silicon carbide and alumina. This indicates a decrease in abrasiveness. The ash derived ceramics can be produced with mean diameters ranging from 3.5 to 35 microns and can be tailored to match the size distribution of the void space in pressed aluminum parts.

The sintering temperature for the P/M aluminum ash MMC is much lower than cast MMC formation (˜600° C. versus ˜700° C.) and the time of sintering can be adjusted. This is important for our application as reactions of the ADC with the aluminum can be controlled to a much higher degree than during stir casting. Also, the materials are premixed, which overcomes problems related to the homogeneity of the MMC.

Two formulations of aluminum powder feedstock materials were studied: ECKA Alumix®123, which is intended for use in the production of precision sintered parts with the alloy composition of Cu (4%), Si (0.5%), and Mg (0.5%); and ECKA Alumix®231, a hypereutectic alloy designed for wear resistance with the alloy composition Cu (2.6%), Si (15%), and Mg (0.7%). The commercial Alumix® materials also contain 1.5% by weight atomized ACRAWAX® C (ethylene bis-stearamide) as a lubricant. ECKA Granules supplied Alumix® powders in three forms: 1) a final mixed product with wax, 2) a final mixed product without wax, and 3) a master batch product consisting of one part that contains the alloying and fluxing agents as well as the wax and a second part that consists of aluminum and alloying powders.

Two ADC materials were selected for study (coarse ADC and ultrafine ADC) and three material handling properties were examined: b 1) dispersion characteristics of the ADC in the Alumix® powders, 2) compressibility of the powders, and 3) flow and compaction of the compounded powders.

Attaining an adequate dispersion of the ADC in the aluminum alloy powder was considered an important handling property. For the first Alumix® formulation (as described above), the coarse and the ultra fine ADC were compounded with the aluminum alloy powder by tumbling in a jar containing a coarse screen or marbles on a roller for no less than 45 minutes. For the second formulation of Alumix®, the powders were compounded and then the wax was added. For the third formulation, the ADC was added to Part B and then compounded with Part A.

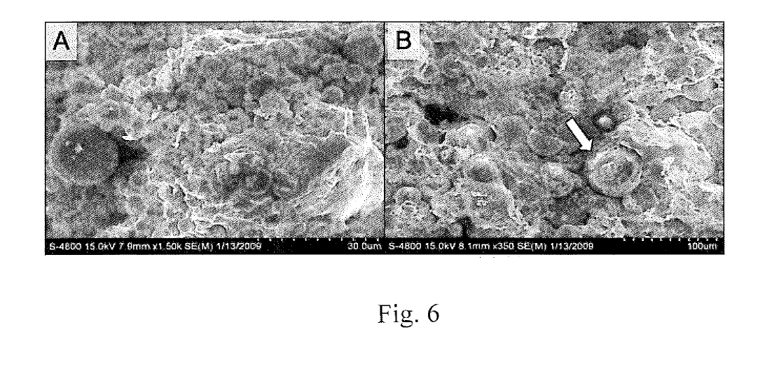

Mixtures of 5% and 10% (by weight) ADC were mixed and compressed into rectangular bars, in accordance with ASTM B312. The bars were sintered and mechanically tested. The quality of dispersion was measured qualitatively with scanning electron microscopy and metallography of select specimens. To summarize a great deal of work (over 500 bars total), the coarse ADC blended better than the ultrafine ADC, regardless of Alumix® formulation. The ultrafine ADC did not disperse well in the presence of wax, which was optically discernable in many of the test bars. (FIG. 6) The third strategy using the master batch appeared to produce somewhat better results optically, but aggregation of the particles, especially the ultrafine ADC, was still discernable as evidenced by inferior transverse rupture strengths.

The second approach to compounding, blending the ADC into aluminum alloy powder without wax, produced the most uniform blend for both coarse and ultrafine materials. When successfully blended, the ADC-Alumix® mixes were found to be stable and showed no signs of segregating when shaken or vibrated. These results clearly indicate that the development of proper blending strategies and protocols will be critical to the development of a commercial product.

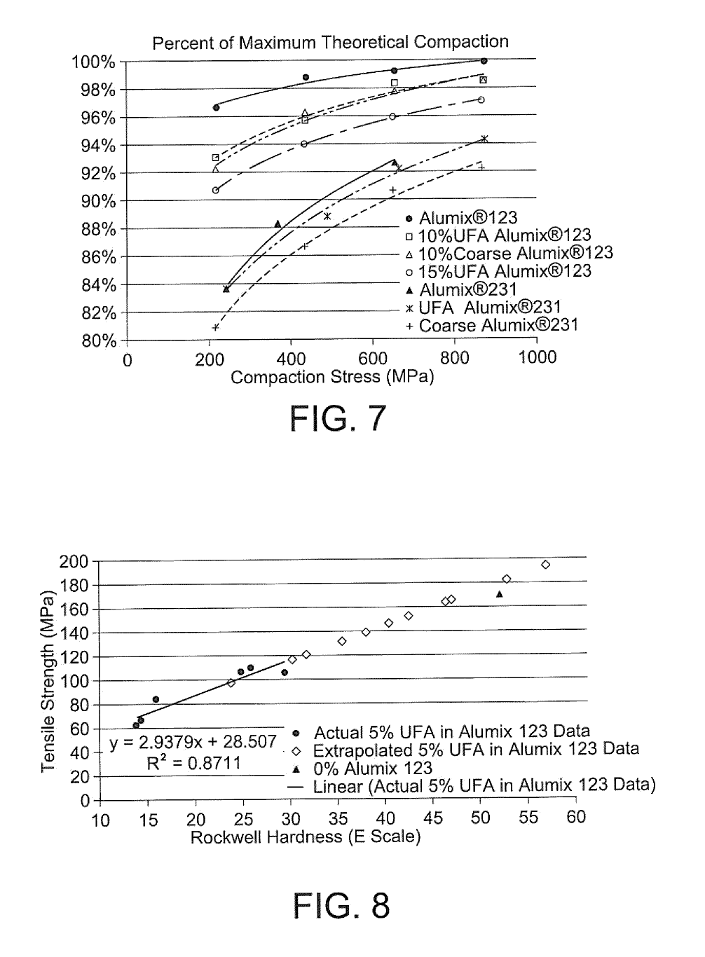

Compaction of the powder mixes was examined as a function of pressure and ADC addition for both ECKA Alumix® materials. The densities of the samples were calculated by measuring the length, width, and mass of the rectangular bars. The data was adjusted for density differences in the ADC, aluminum, and wax and is plotted as percent of theoretical maximum density for different compaction stresses. (FIG. 7) As expected, the applied stress needed to maintain the same relative density increased when incompressible ADC was mixed with malleable aluminum alloy. Alumix®231 is a high silica material that is very hard, which is reflected in lower compaction percentages relative to Alumix®123.

Green strength, defined as the strength of a pressed part before sintering, was measured for coarse and ultrafine ADC in Alumix®123 powder (ASTM B312). It was considered that a minimum green strength of 600 psi (4.1 MPa) was needed for most commercial applications although the ASTM standard calls for 800 psi (5.5 MPa). The measured green strengths ranged from 7 MPa for the 10% UFA-Alumix®123 to a high of 19.2 MPa for the 5% UFA-Alumix®123 with the 5% and 10% coarse composite materials at 12.1 MPa and 9.9 MPa, respectively. For comparison, the green strength of Alumix®123 was 13.6 MPa. The green strength of our materials greatly exceeded the requirements for commercial applications.

A Carney flowmeter was used to show that the Alumix®123 (18 sec/50 g) poured the fastest with 5% ultrafine ADC-Alumix®123 (23 sec/50 g) slightly slower and the 10% ultrafine ADC-Alumix®123 powder (40 sec/50 g) the slowest. Our discussions with Nic Veloff at ECKA Granules concluded that these flows do not represent a problem and could be readily improved without changing the composition of the powders.

The apparent densities of the powders greatly increased with increasing concentration of ultrafine ADC's: 1.13 g/cm³ for Alumix®123, 1.20 g/cm³ for 5% ADC-Alumix®123, and 1.23 g/cm³ for 10% ADC-Alumix®123. This is indicative of the ultrafine ceramics filling the void space in aluminum alloy powders—an effect that was considered useful to formulate a product with improved properties.

Sintering plays a major role in determining the final product. Varying the temperature, soak time, and heating rate can dramatically affect the physical and mechanical properties of the resulting composite material. Originally, we proposed to optimize the formulation of the compounded powders using pressed bars and green strength determinations rather than conducting numerous sintering tests. This was not viable, as green strength did not clearly correlate with sintered strength. Thus, most of the exploratory work was performed on bars produced by varying the pressure, sintering temperature, and soak time.

Typically, pressed aluminum parts are sintered at ˜590° C. in a nitrogen atmosphere that is sometimes blended with a smaller percentage of hydrogen. ECKA recommends sintering temperatures and soak times of 600° C. for 20 minutes for Alumix®123 and 540° C. for 60 minutes for Alumix®231. The interactions between the ADC and aluminum alloy powders were separate from the sintering reactions. In order to incorporate control over the former, the time and temperature profiles for sintering were altered. For example, we found that increasing the temperature from 600° C. to 625° C. increased the average transverse rupture strength of 5% Coarse-Alumix®123 from 239.2 MPa to 244.6 MPa. Also, varying the soaking time dramatically impacted the properties of the resulting materials—extending the soak time of 10% UFA-Alumix®123 at 625° C. from 20 to 60 minutes increased the transverse rupture strength from 126.2 MPa to 148.3 MPa.

There are two important tests used in the characterization of P/M materials. The first is the test for transverse rupture strength (TRS), which is described in ASTM B528 procedure, and the second is the test for hardness.

A double action die was used to press the compounded powders into standard rectangular bars (5.35 mm×12.7 mm×31.75 mm). Transverse rupture strength was measured by loading pressed and sintered rectangular bars to failure in three-point bending with a constant rate of deformation (5 min/min). The load corresponding to failure was used to calculate the TRS. The majority of the bars pressed from compounded powders were tested using this method. This test was ideal for exploration of P/M MMCs because it is relatively quick, very reproducible, and well suited for reinforced aluminum alloys, which are more brittle than their unreinforced counterparts. TRS data on MMC's cannot be compared directly to conventional Aluminum P/M alloys due to the latter's greater ductility. During the three-point bending test, the beams of the testing jig pressed into the aluminum bars leaving impressions. This permanent deformation at the points of contact falsely exaggerated the measured TRS strength values.

In an attempt to generate some level of comparison between the physical properties of the P/M MMC and the conventional P/M alloys, a few materials were selected to undergo tensile testing as described in ASTM E8 (for powder metallurgy materials). This testing requires that the compounded powders be pressed into dog-bone bars. The specimens were tested using an Instron materials testing system located at the University of Kentucky.

Hardness is equally as important as strength for applications that require some form of wear resistance. The hardness of ADC-aluminum MMCs was measured using the test for Vickers micro-hardness and the test for Rockwell Hardness (E scale). Preparatory to measuring the Vickers micro-hardness, the pressed bars were embedded in epoxy and polished to achieve a near mirror finish. During the test, a load of 200 grams was applied and slowly released. The diagonal markings left in the impression of the pyramidal tip were measured, averaged, and used to calculate the micro-hardness number.

Alternatively, the Rockwell test (E scale) was used to determine hardness on the macroscale. This test involved penetrating the flat surface of a pressed sample with a load of 100 grams on a ⅛″ silicon carbide ball tip on the penetrating shaft. Rockwell hardness is known to correlate with other material properties, such as tensile strength. Unfortunately, the mismatch of scales did not allow a direct correlation between Vickers micro-hardness and Rockwell hardness.

We plotted the measured tensile strengths from the dog-bone bars pressed by ECKA against the corresponding measured Rockwell hardness for the 5% UFA-Alumix®123 material, which exhibited the most promising strength characteristics. The two data sets were correlated and a best-fit line was drawn (FIG. 8). The equation of the regression line was used to extrapolate tensile strengths for other 5% UFA-Alumix®123 specimens that were pressed and sintered with various conditions and whose hardness was previously measured. Plotting the extrapolated data along with the measured values for Alumix®123 revealed that the strength of the 5% UFA materials could be improved to exceed the measured tensile strength of Alumix®123. in a separate experiment, modest amounts of ultrafine and coarse ADC increased the Vicker' s micro-hardness of Alumix®123 by 50.9% and 45.7%, respectively, when sintered at 650° C. This sintering temperature, which is higher than normal, was not frequently used because it was associated with specimen deformation.

The transverse rupture strength (TRS) of Alumix®123 reinforced with ash derived ceramics was dependent on a number of factors including sintering temperature, ceramic type (i.e. ultra fine or coarse), and compounding method. To examine these parameters more closely, the TRS of several materials were compared. Feedstock powders of Alumix®123 supplemented with 5% and 10% of ultra fine (UFA) and coarse ash derived ceramics were compounded using one of two methods: 1) mixing ADC into Alumix®123 powder and then adding wax (Pre-Wax), or 2) mixing ADC into aluminum powder and then compounding with wax containing alloying powders (Master Mix).

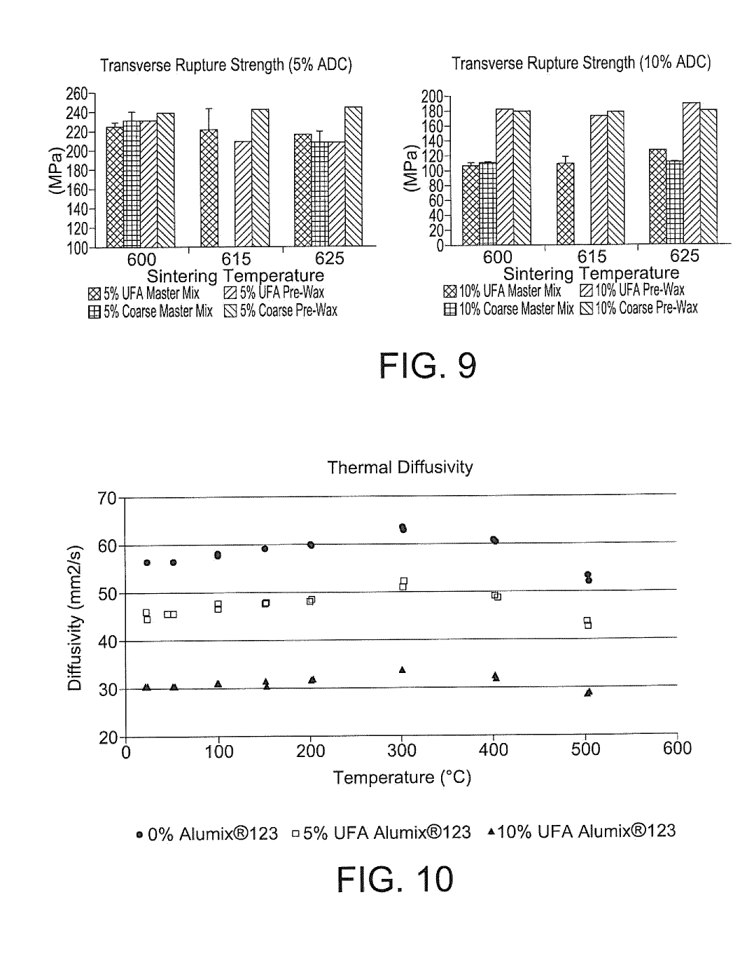

Three sintering temperatures were investigated (600° C., 615° C., and 625° C.). The coupons were sintered in high purity nitrogen (99.99%) for twenty minutes. The sintered coupons were tested to failure and the transverse rupture strengths were recorded. (FIG. 9) The results clearly showed that out of all the Alumix®123 materials reinforced with 5% ash derived ceramics, the material with coarse additive and compounded with the Pre-Wax method was superior. In general, the Pre-Wax compounding method was superior to the Master Mix compounding method. Similarly, coarse ash derived ceramics outperformed the ultrafine ash derived ceramics as an additive.

With regard to sintering temperature, the effect on strength varied. For the 5% UFA-Alumix®123 materials and the 5% Coarse-Alumix®123 compounded with the Master Mix method, the strength decreased as the sintering temperature increased. Alternatively, the strength of the 5% Coarse-Alumix®123 compound with the Pre-Wax method slightly increased with increasing sintering temperature. This is likely due to improved dispersion of the coarse materials by mixing prior to adding the wax, which is likely a cause of phase segregation and agglomeration. Further, less than ideal dispersion (as is the case with the Master Mix method) creates pockets of agglomerations, which serve as stress concentrators and weaken the material.

Additionally, the coarse ceramic additives, which are insulating by nature, probably absorb some of the heat away from the aluminum particles, thus, preventing the necessary reactions between the ADC and aluminum. Elevating the sintering temperature would counteract this effect. This is supported by the thermal diffusivity measurements made on Alumix®123 with and without ultrafine ADC. (FIG. 10) As ADC content increased the thermal diffusivity decreased dramatically. In other words, the ADC slowed the transport of heat throughout the material, thus, making it less likely to react at standard sintering conditions. Therefore, increasing the sintering temperature dramatically affected the mechanical properties of the ADC-Alumix®123 composite materials.

There are accordingly provided methods for forming metal matrix composites via a variety of techniques, and metal matrix composites formed thereby. The subject ADC were found to be easily wetted and were compatible in the melt in stir casting techniques, and individual bars with modulus as high as 20 GPa and tensile strengths as high as 147 MPa (21,300 psi) were cast. The materials exhibited good machinability with silicon carbide testing. The ADC powder was found to be compatible with the PIM aluminum powder, as the powder mixes were stable when blended. The ADC increased the apparent density of the metal powders. Indeed, coarse ADC at a weight fraction of 5% was capable of achieving strengths and hardness that exceeded the reference alloys.

These materials find use in applications that require decreased weight and cost savings without sacrificing performance. For example, ADC-aluminum metal matrix composites could be used as engine blocks or brake rotors in automobiles. The presence of the ADC will harden the aluminum making it more compatible with such applications. Additionally, the weight savings over ductile iron will add to the fuel economy and energy efficiency of the vehicle. Ash derived ceramics are recycled from an energy product making them sustainable and environmentally friendly materials.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the present disclosure, appended Exhibit, and claims, when interpreted in accordance with the breadth to which they are fairly, legally and equitably entitled.

What is claimed is:

1. A method for preparing a metal-fly ash composite material, comprising:
classifying a fly ash-containing material to provide a classified fly ash material having a mean particle size of from about 4 μm to about 40 μm;
blending the classified fly ash material with a metal matrix whereby the fly ash material and the metal matrix form a substantially homogenous mixture; and
subjecting the mixture to suitable conditions of temperature and/or pressure whereby a metal-fly ash composite material is formed.

2. The method of claim 1, further including subjecting the classified fly ash material to a secondary thickening process prior to the step of combining with a metal matrix.

3. The method of claim 1, further including a step of removing magnetic particles from the classified fly ash material prior to the step of blending with a metal matrix.

4. The method of claim 1, wherein the fly ash containing material is derived from coal.

5. The method of claim 4, wherein the classified fly ash material is included in an amount of from about 5 vol % to about 25 vol % of the classified fly ash-metal matrix mixture.

6. The method of claim 1, wherein the metal matrix is aluminum or an aluminum alloy.

7. The method of claim 6, wherein the metal matrix is provided as a melt.

8. The method of claim 6, wherein the metal matrix is provided as a powder.

9. The method of claim 7, including the step of blending the classified fly ash material and the metal matrix melt in a substantially oxygen-free environment.

10. The method of claim 8, further including the step of subjecting the classified fly ash material-metal matrix powder to a pressure sufficient to form a metal-fly ash composite material.

11. The method of claim 10, further including the step of sintering the metal-fly ash composite material.
